(19) United States
(12) Patent Application Publication
(10) Pub. No.: US 2002/0189946 A1
(43) Pub. Date: Dec. 19, 2002

(54) Microfluidic injection and separation system and method

(75) Inventors: Ann K. Wainright, Cupertino, CA (US); Stephen J. Williams, San Mateo, CA (US)

Correspondence Address: PERKINS COIE LLP, P.O. BOX 2168, MENLO PARK, CA, 94026, US

(73) Assignee: Aclara BioSciences, Inc.

(21) Appl. No.: 10/113,170

(22) Filed: Mar. 29, 2002

Related U.S. Application Data
(63) Continuation-in-part of application No. 10/034,278, filed on Dec. 28, 2001.
Application No. 10/034,278 is a continuation-in-part of application No. 09/780,638, filed on Feb. 10, 2001.
Application No. 09/780,638 is a continuation-in-part of application No. 09/933,993, filed on Aug. 20, 2001.
(60) Provisional application No. 60/182,049, filed on Feb. 11, 2000.
(60) Provisional application No. 60/185,035, filed on Feb. 25, 2000.

(51) Int. Cl. G01N 27/26; G01N 27/447

(52) U.S. Cl. 204/453; 204/604

(57) ABSTRACT

Methods of sample loading and separation in a microfluidics device are described. The methods provide high resolution and high signal intensity, using, in a preferred embodiment, a simple two-electrode injection scheme with isotachophoretic (ITP) stacking, followed by ZE separation in the same channel.

This application is a continuation-in-part of copending U.S. application Ser. No. 10/034,278, filed Dec. 28, 2001, which is a continuation-in-part of U.S. application Ser. No. 09/780,638, filed Feb. 10, 2001, which is a continuation-in-part of U.S. application. Ser. No. 09/933,993, filed Aug. 20, 2001, all of which in turn claim the benefit of U.S. Provisional Applications having Serial Nos. 60/182,049, filed Feb. 11, 2000, and 60/185,035, filed Feb. 25, 2000. All of these applications are hereby incorporated by reference in their entirety and for all purposes.

### FIELD OF THE INVENTION

The invention relates to methods of zone electrophoretic (ZE) separation of charged components in a microfluidics device. More particularly, the invention is concerned with sample pre-concentration or stacking by isotachophoresis (ITP), followed by sample separation by capillary zone electrophoresis (CZE) on a microfluidic device, enabling high detection sensitivity with automated sample processing.

### REFERENCES

R. Aebersold, H. D. Morrison, J. Chromatogr. 516:79 (1990).

R. Bodor et al., J. Chromatography A 916:155-165 (May 2001).

R. Bodor et al., J. Sep. Sci 24:802-809 (September 2001).

D. S. Burgi, R.- L. Chien, Anal. Chem. 63:2042 (1991).

S. Chen, M. L. Lee, Anal. Chem. 72:816 (2000).

R.- L. Chien, D. S. Burgi, Anal. Chem. 64:1046 (1992).

M. T. Cronin, T. Boone, A. P. Sassi, H. Tan, Q. Xue, S. J. Williams, A. J. Ricco, H. H. Hooper, J. Assn. for Laboratory Automation 6(1):74 (2001).

M. Dankova et al., J. Chrom. A 838:31-43 (April 1999).

F. M. Everaerts, T. P. Verheggen, F. E. P. Mikkers, J. Chromatogr. 169:21 (1979).

F. Foret, V. Sustacek, P. Bocek, J. Microcol. 229 (Sep. 2 1990).

D. Kaniansky, M. Masár, J. Bielcikova, F. Iványi, F. Eisenbeiss, B. Stanislawski, B. Grass, A. Neyer, M. Jöhnck, Anal. Chem. 72(15):3596 (2000).

R. M. McCormick, N. J. Nelson, M. G. Alonso-Amigo, D. J. Benvegnu, H. H. Hooper, Anal. Chem. 69:2626 (1997).

F. E. P. Mikkers, F. M. Everaerts, T. P. Verheggen, J. Chromatogr. 169:11 (1979).

A. Sassi, I. Cruzado, T. Björnson, H. Hooper, A. Paulus, J. Chromatogr. A 894:203 (2000).

T. J. Thompson, F. Foret, P. Vouros, B. L. Karger, Anal. Chem. 65:900 (1993).

T. P. Verheggen et al., J. Chromatog. 452:615-622 (1988).

D. J. Weiss, K. Saunders, C. E. Lunte, Electrophoresis 22:59 (2001).

Q. Xue, A. Wainright, S. Gangakhedkar, I. Gibbons, Electrophoresis 22:4000 (2001).

Y. Zhao, C. E. Lunte, Anal. Chem. 71:3985 (1999).

### BACKGROUND OF THE INVENTION

Microfluidic technology is revolutionizing a substantial segment of the field of chemical and physical processing of various fluids. One area of microfluidics concerns the manipulation of small volumes of liquids on a solid substrate having a network of channels and reservoirs, typically in communication with voltage sources. By applying electric fields to electrically conducting liquids, volumes of fluid and/or ions can be moved from one site to another, different solutions can be formed by mixing liquids and/or ions, and various reactions, separations, and analyses can be carried out. In fact, in common parlance, such a system has been referred to as “a laboratory on a chip.” Various prior art devices of this type include those described in U.S. Pat. Nos. 6,010,608, 6,010,607, 6,001,229, 5,858,195, and 5,858,187, which stem from a family of applications concerned with injection of sample solutions, as well as the disclosures of U.S. Pat. No. 5,599,432, EP Publication No. 0620432 A, and Verheggen et al.

Many of the operations performed on such devices involve the separation by zone electrophoresis (ZE) of multiple sample components contained in dilute samples, e.g., samples with concentrations of sample components in the femtomolar to nanomolar range. Efficient electrophoretic injection of low-concentration samples can require large sample volumes, which, in conventional zone electrophoresis, frequently results in poor resolution of the sample components.

Methods used to increase the sample loading capacity and thus detection sensitivity in capillary zone electrophoresis (CZE) have included field amplification stacking (FAS) (Mikkers et al.; Burgi et al.; Chien et al.), pH mediated stacking (Aebersold et al.; Zhao et al.; Weiss et al.), and ITP (isotachophoresis)/CZE, in which sample components are compressed into a small volume by isotachophoretic stacking, followed by electrophoretic separation. This technique typically employs coupled capillaries, as first proposed by Everaerts et al (1979) and later shown in automated form (Dankova et al.; Thompson et al.; Foret et al.). Chen and Lee (2000) describe a method of preventing overloading of the CZE column in ITP/CZE, by injecting repeated aliquots of ITP-stacked sample onto the CZE column, with the necessity of refocusing the ITP sample prior to each injection. Column coupling configurations of separation channels in fabricated microchips have been reported for carrying out ZE with on-line ITP sample pre-treatment (ITP/ZE) (Bodor et al.; Kaniansky et al.). Reports of ITP/ZE procedures are frequently concerned with removal of large quantities of non-analyte matrix constituents, such as chloride and sulfate, from an ITP-stacked sample prior to ZE analysis of lower concentration analyte constituents.

There continues to be a need for increased sensitivity and automation of sample processing in ZE separations. It would thus be desirable to provide readily automated, high sensitivity electrophoretic methods for separation and resolution of sample components present in low concentrations. Ideally, the method would enable high sensitivity analyses to be run in low salt or high salt biological buffers, or in biological samples, with little or no sample pretreatment.

### SUMMARY OF THE INVENTION

In one aspect, the invention provides a method for injecting a sample comprising a plurality of charged components and separating the components by electrophoresis in a microfluidics device, where the microfluidics device includes:

a separation channel, having an upstream junction at which first and second channels intersect, the first and second channels terminating in first and second reservoirs, designated T and S/D, respectively;

a first side channel, intersecting the separation channel downstream of said junction, and terminating in a first side reservoir, designated D/S; and

a second side channel intersecting any one of the separation channel, first channel, and second channel, and terminating in a second side reservoir, designated L. For example, in one embodiment, the second side channel intersects the separation channel, downstream of the first side channel. In other embodiments, the second side channel intersects the first or second channel, or, the second side channel intersects the separation channel at a position directly opposite the first side channel.

Preferably, the sample-loading region of the separation channel, defined as the region between the upstream junction and the first side channel, is about 0.5-5 cm in length.

The microfluidics device further includes an outlet reservoir at a downstream terminus of the separation channel, and, for each reservoir, an electrode in fluid contact with the reservoir. In one embodiment, the electrodes are controlled by a single high voltage power source which employs multiplexed switching among the electrodes. The method comprises the steps of:

(a) placing into the channels and reservoirs of the device, a leading electrolyte solution, comprising an ion with higher mobility in an electric field than any of the charged sample components;

(b) placing into either the S/D reservoir or the D/S reservoir, the sample solution, and placing into the T reservoir, a terminating electrolyte solution, comprising an ion with lower mobility in an electric field than any of the charged sample components; and

(c) creating a voltage gradient between the S/D reservoir and the D/S reservoir, such that the sample solution migrates into a sample-loading region of the separation channel, between the upstream junction and the first side channel.

The sample solution may be placed into reservoir S/D in step (b), such that in step (c), the sample solution migrates into the separation channel region in a downstream direction. Alternatively, the sample solution may be placed into reservoir D/S in step (b), and in step (c), the sample solution migrates into the separation channel region in an upstream direction. In addition, the second side channel may contains a leading electrolyte solution which is different from that used to fill the remaining channels in step (a).

The method further comprises, following sample injection, the steps of:

(d) creating a voltage gradient between the T reservoir and the S/D reservoir, such that the terminating electrolyte solution migrates through the first channel, to an upstream boundary of the sample solution in the sample-loading region, and into the second channel;

(e) creating a voltage gradient between the T reservoir and the outlet reservoir, such that the sample components become stacked within a region of the separation channel which is downstream of the second side channel; and

(f) creating a voltage gradient between the L reservoir and the outlet reservoir, such that leading electrolyte solution migrates from the second side channel, to an upstream boundary of the stacked sample components, and through the stacked components,

whereby the sample components move through the separation channel and separate into discrete bands according to their electrophoretic mobilities.

Preferably, the separated sample components are detected within the device, typically by detection of fluorescent labels on the components.

In a preferred embodiment of the method, in each of steps (c)-(f), voltages are applied to the two electrodes specified, and the remaining electrodes are in a floating state. However, voltages may also be applied to other electrodes in the system, as described further below.

In a variation on the above method, which provides controllable variable sample injection, the method further comprises, following step (c) and prior to step (d) above: creating a voltage gradient between (i) a reservoir downstream of the first side channel and (ii) reservoir S/D, such that a desired amount of sample solution is displaced from the sample-loading region into the S/D channel. The downstream reservoir (i) may be the outlet reservoir, or, where the second side channel intersects the separation channel downstream of the first side channel, the reservoir designated L.

The charged components of the sample may include, for example, nucleic acids, proteins, polypeptides, polysaccharides, or charged synthetic polymers. In one embodiment, the charged components comprise labeled molecules having distinct and characterized electrophoretic mobilities, the molecules having been cleaved from molecular species with biological or chemical recognition properties in the course of a multiplexed chemical or biochemical assay. In this case, the sample solution may further comprise a cell lysate and reagents used in the assay, or, the sample solution may further comprise live cells and reagents used in the assay.

Samples may also include clinical samples derived from body fluid or tissue samples, or samples of environmental origins. The method is useful for detection of very low levels of analyte; in preferred embodiments of the method, the concentration of at least one detected sample component in the sample is less than 1 pM.

These and other objects of the invention will become more fully apparent when the following detailed description of the invention is read in conjunction with the accompanying drawings.

### BRIEF DESCRIPTION OF THE FIGURES

FIG. 1 illustrates a microfluidics system useful for carrying out the separation methods of the invention;

FIGS. 2A-2F are a schematic illustration of isotachophoretic (ITP) stacking followed by electrophoretic separation, in accordance with an embodiment of the invention (dimensions and regions not necessarily shown to scale);

FIG. 3 shows detection of stacked sample (left side of scan) and separated sample (right side of scan) in different regions of a microfluid device, where samples components are stacked and then separated, according to an embodiment of the invention;

FIGS. 4A-4C show the increase in sensitivity obtained by ITP/ZE in accordance with the method of the invention, as compared to ZE separation of similar samples (eTag™ reporter molecules) at higher concentrations;

FIGS. 5A-5B show ITP/ZE separations of 13 eTag™ reporters in different sample buffers of varying conductivity;

FIG. 6 shows ITP/ZE separation of eTag™ reporters present in low pM concentrations in eTag™ assay buffer;

FIG. 7 shows ITP/ZE separation of cell lysate samples: scan A: eTag™ reporters in cell lysate at 200-400 pM; scan B: cell lysate blank with assay reagents; scan C: buffer blank (eTag assay buffer); and

FIGS. 8A-8B show the effectiveness of ITP/ZE separation, in accordance with an embodiment of the invention, in detection of peptide cleavage by a cell surface protease, where samples were injected directly from physiological buffers (Hanks' buffer).

### DETAILED DESCRIPTION OF THE INVENTION

I. Microfluidic System

Polymeric microfluidic devices for high throughput genomic and proteomic analysis and drug screening are described in Cronin et al., McCormick et al., Sassi et al., and Xue et al, in co-owned U.S. application Ser. Nos. 09/780,638 and 09/933,993, and in co-owned PCT Pubn. No. WO 01/59440. One such device, the LabCard™ produced by ACLARA Biosciences Inc., can contain many individual separation elements on one card (Cronin et al., Sassi et al.). Current microfabrication technology allows fabrication of complex patterns of interconnecting channels with densely packed patterns, which can be inexpensively replicated from masters by injection molding.

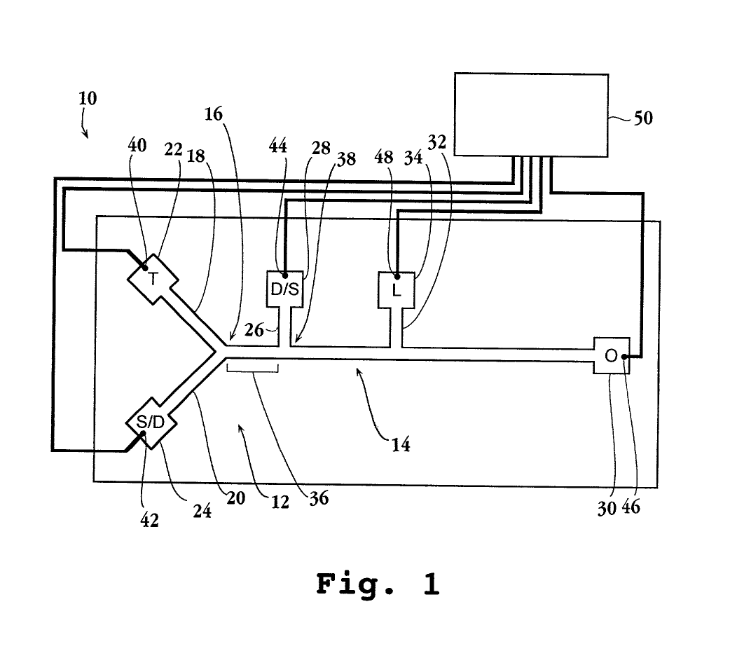

FIG. 1 illustrates one example of a microfluidic system useful for electrophoretic separation of components having a given negative or positive charge and contained in a dilute sample. By “sample” is meant an aqueous sample containing one or more charged components which can be separated electrophoretically, and preferably detected by standard optical techniques applicable to capillary zone electrophoresis. By “dilute sample” is meant a sample in which at least one of the components to be separated and detected is present at a concentration as low as about 50 fM (femtomolar) to about 1 pM (picomolar), as well as higher concentrations, e.g., several hundred nanomolar of higher, preferably in the 1-500 pM range. More concentrated samples, e.g. up to about 100 μM, may also be used.

The microfluidics device 10 of FIG. 1 contains a channel network, indicated generally at 12. The channel network includes an electrolyte channel 14, having an upstream junction 16 at which first and second channels 18 and 20 intersect. Each of the first and second channels terminates in a buffer or electrolyte reservoir, indicated at 22 and 24 and designated T and S/D, respectively. Note that these reservoirs may function interchangeably, and that first and second channels 18 and 20 may be arranged such that either or both form right angles with electrolyte channel 14.

The device also includes, downstream (i.e. to the right in the figure) of junction 16, and intersecting channel 14, a first side channel 26, which terminates in a reservoir 28, designated D/S. Channel 14 terminates in a downstream or outlet reservoir 30, designated O. The network also includes a second side channel 32, which intersects any one of electrolyte channel 14 (as shown in the Figure), first channel 18, and second channel 20. It terminates in reservoir 34, designated L. In the embodiment shown in FIG. 1, the second side channel intersects electrolyte channel 14, downstream of first side channel 26.

A sample-loading region 36 is defined by upstream junction 16 and junction 38 of first side channel 26 with the electrolyte channel. In operation, as will be described below, sample is injected into this region and subsequently moved in a downstream direction (toward the right in the figure) in the electrolyte channel.

At least one, and preferably all, of the reservoirs have ports (not shown) at which liquid material can be added to the reservoirs. Each reservoir includes, or is adapted to receive, an electrode, such as electrodes 40, 42, 44, 46, and 48 in reservoirs 22, 24, 28, 30, and 34, respectively. The electrodes may be formed on the substrate or formed independently, e.g., on an electrode plate for placement on the substrate for electrode contact with liquid in the associated reservoirs. Each electrode, in turn, is operatively connected to a control unit or voltage controller 50, which operates in various modes described below.

Although only a single channel network is shown in the Figure, the device may include an array of channel networks, each having the general features described for network 12. In this embodiment, the device may include micropatterned conductors connecting each of the corresponding reservoirs in the networks to a common lead for connection to the control unit.

The channel dimensions are generally in the range of about 0.1 μM to 1 mm deep and about 0.5 μm to 1 mm wide, more typically about 10 to 200 μm in either dimension, where the cross-section is generally 0.1 μm² to about 1 mm². The main (separation) and side channels may have the same or different cross-sectional areas, as well as the same or different shapes.

The channel lengths may vary widely depending on the operation for which the channel is to be used, generally being in the range of about 0.05 mm to 50 cm, more usually in the range of about 0.5 mm to 20 cm. Typical dimensions for use in the separation methods described herein as are follows: sample loading region, 0.1 to 5 cm, preferably 0.5 to 5 cm, typically about 2 cm; first side channel to second side channel (in the embodiment of FIG. 1), 0 to about 1.2 cm; and second side channel to outlet (in the embodiment of FIG. 1), about 3 to 8 cm. (A first side channel to second side channel distance of zero indicates that these two channels are on opposing sides of the electrolyte channel.)

The reservoirs generally have volumes in the range of about 10 nl to 100 μl; more usually in the range of about 500 nl to 10 μl. The reservoirs may be cylindrically shaped, conically shaped, e.g. the frustum, or other regular shape.

With respect to the fabrication of the microfluidics device, the channel network may be conventionally formed on a substrate or card, such as a silicon or polymeric substrate, and covered by a transparent cover or film, which is attached or bonded to the card in a conventional manner. The substrate may be a flexible film or relatively inflexible solid, where the microstructures, such as reservoirs and channels, may be provided by embossing, molding, machining, etc. The substrate generally has a thickness of at least about 20 μm, more usually at least about 40 μm, and not more than about 0.5 cm, usually not more than about 0.25 cm. The width of the substrate is determined by the number of units to be accommodated and may be as small as about 2 mm or up to about 6 cm or more.

The fabrication of the device may include fabrication of the substrate comprising the microfeatures, a supporting film, an enclosing film, or combinations thereof. A supporting film will generally be at least about 40 μm and not more than about 5 mm thick. The film used to enclose the channels and the bottom of the reservoirs generally has a thickness in the range of about 10 μm to 2 mm, more usually in the range of about 20 μm to 1 mm. The selected thickness may be controlled by the desire for good heat transfer, e.g. temperature control, but otherwise is usually selected for convenience and assurance of good sealing and the manner in which the devices will be used to accommodate instrumentation. The enclosing film, where the bottom of the substrate is totally closed, will also have a thickness coming within the above range, and will include perforations in register with the reservoirs or other feature requiring access, while enclosing the channels. Therefore, the ranges are not critical.

As indicated, the substrate may be a flexible film or inflexible solid, so the method of fabrication will vary with the nature of the substrate. For embossing, at least two films will be used, where the films may be drawn from rolls, one film embossed and the other film adhered to the embossed film to provide a physical support. The individual units may be scored, so as to be capable of being used separately, or the roll of devices retained intact. See, for example, co-owned PCT Pubn. No. WO 99/19717. Where the devices are fabricated individually, they are usually molded, using conventional molding techniques. The substrates and accompanying film are generally plastic, particularly organic polymers, where the polymers include addition polymers, such as acrylates, methacrylates, polyolefins, polystyrene, etc., or condensation polymers, such as polyethers, polyesters, polyamides, polyimides, dialkyl siloxanes, or norborane (“ZEONOR”-type) polymers, although glasses, silicon or other material may be employed. Desirably, the polymers have low fluorescence inherently or can be made so by additives or bleaching, e.g. photobleaching. A film is usually be placed over the substrate to enclose at least the channels, which film usually has openings for communicating with the reservoirs and, where appropriate, introducing electrodes into the reservoirs. The enclosing film is adhered to a substrate by any convenient means, such as thermal bonding, adhesives, etc. The literature has many examples of adhering such films; see, for example, U.S. Pat. Nos. 4,558,333 and 5,500,071.

The control unit includes a power source or voltage source which is operatively connected to the electrodes in the device. The power source is under the control of an electronic controller in the control device. The controller determines the sequence and timing of voltages applied to the electrodes, and the voltage levels, in carrying out the method of the invention. In a preferred embodiment, the electrodes are controlled by a single high voltage power source which employs multiplexed switching among the electrodes. The operation and design of the controller will be appreciated from the operation of the device described below.

Sample-Component Separation Method

A. Injection and Separation Procedures

The separation method involves an initial sample-stacking step carried out under isotachophoretic (ITP) conditions. The electrolyte components of the background and sample solutions are selected, particularly in relation to the length of the sample volume region, i.e., total sample volume, to permit the sample to initially stack into a small volume by ITP, which is then efficiently separated in the same channel by ZE. The theory and practice of isotachophoretic separation is described, e.g., in Everaerts, Beckers, & Verheggen, Isotachophoresis. Theory, Instrumentation and Applications; Elsevier: Amsterdam, 1976.

The descriptions of the separation method will refer to a microfluidic device such as that shown in FIG. 1. As described below, either reservoir S/D or D/S can be used as the sample reservoir, and the other as the “drain” reservoir.

In the figures, the sample components to be separated are negatively charged, the electrolytes are chosen accordingly, and the polarity of voltage is applied with the polarity shown. The processes described herein can clearly be applied to positively charged components by altering the voltages and electrolytes accordingly.

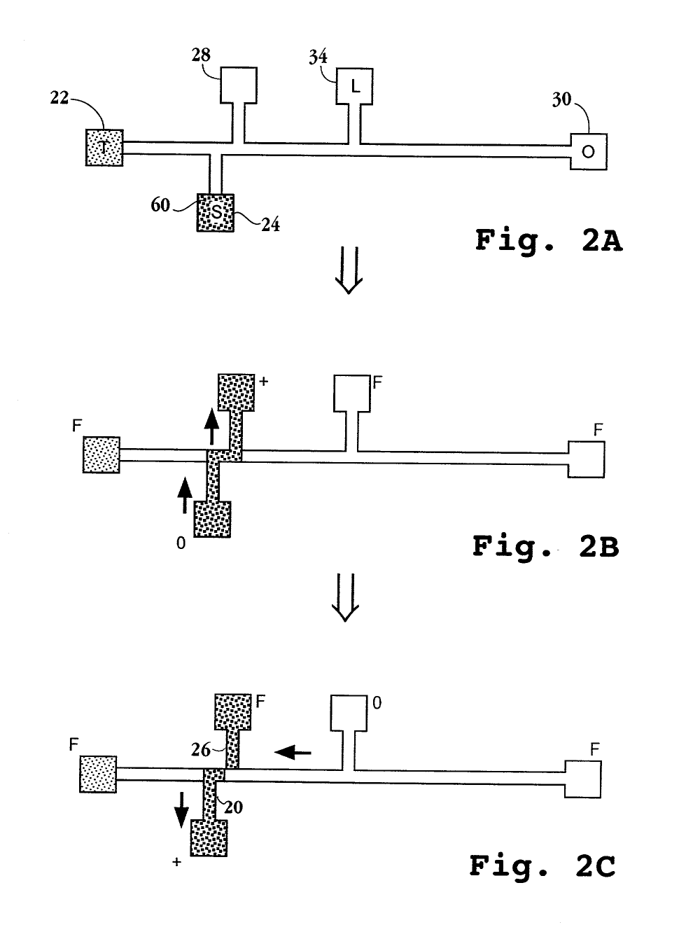

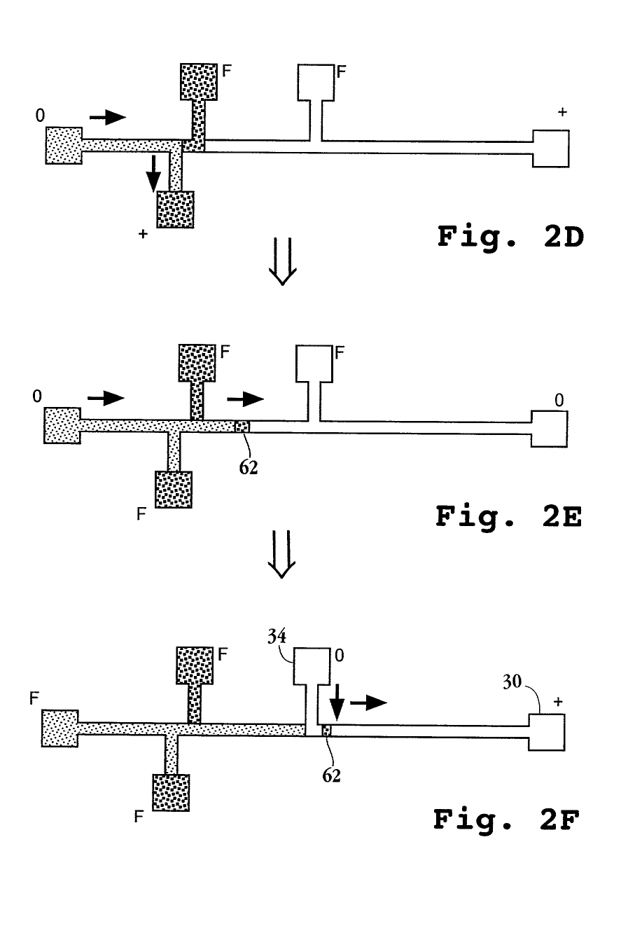

With reference to FIG. 2A, the channels of the device are filled with an solution of an electrolyte comprising an anion having higher electrophoretic mobility than any of the sample components (leading electrolyte). In one embodiment, reservoir 34 (L) contains a leading electrolyte different from that used to fill the channels in the device.

A sample 60, containing, in this case, negatively charged sample components with different electrophoretic mobilities, is provided in a buffer solution, where the buffer comprises an anion having lower mobility than the leading electrolyte anion. The sample solution is placed in reservoir 24 (as shown in FIG. 2A) or reservoir 28. Reservoir 22 (T) is filled with a terminating electrolyte solution, comprising an ion having lower electrophoretic mobility than any of the sample components.

For sample injection, a voltage gradient is created between the “sample” reservoir and the “drain” reservoir. As shown in FIG. 2B, a positive voltage is applied between reservoir 28 (D/S) and reservoir 24 (S/D). Typically, the voltage applied is a DC voltage of between 10-5000 volts. For example, a positive voltage is applied to the electrode in contact with reservoir 28, and the electrode in contact with reservoir 24 is grounded, effective to create a field strength of about 200-800 V/cm.

A bolus of sample solution is thereby injected into sample-injection region 36 (see FIG. 1), as shown in FIG. 2B. It can be seen that, by placing sample in reservoir 28 (D/S) and applying the positive voltage to reservoir 24 (S/D), a similar injection could be carried out.

Following sample injection, electrode control is then switched such that a positive voltage is applied to reservoir 24 (S/D), and reservoir 22 (T) is grounded (FIG. 2D). (The optional operation shown in FIG. 2C is discussed below.) This results in terminating electrolyte from upstream reservoir 22 migrating to an upstream boundary of the sample solution in the sample-injection region, as shown in FIG. 2D, thus sandwiching the sample between leading and terminating electrolyte.

In one embodiment, following sample injection (FIG. 2B) and prior to migration of the terminating electrolyte from reservoir 22 (FIG. 2D), a voltage gradient is created between (i) a selected reservoir downstream of first side channel 26 and (ii) reservoir 24 (S/D), such that a desired amount of sample solution is displaced from sample-loading region 36 back into the S/D channel (20) (FIG. 2C). This process, termed herein “variable sample injection”, allows the amount of sample in the electrolyte channel to be adjusted to a desired level by timing and voltage control prior to separation, thus allowing injection of variable sample amounts. The use of a long (e.g. 2 to 5 cm) sample loading region allows more accurate control of the sample amount in the sample channel segment.

Following migration of the terminating electrolyte, as described above and illustrated in FIG. 2D, a positive voltage gradient is applied between upstream reservoir 22 (T) and outlet reservoir 30; e.g., a high positive voltage is applied to reservoir 30, and reservoir 22 (T) is grounded (FIG. 2E). The sample components become stacked within the electrolyte channel, e.g. as illustrated at 62, according to known principles. Briefly, each sample component migrates to a position closely adjacent the sample components nearest in electrophoretic mobility, causing the components to stack into a tight sample band of separated components between the high- and low-mobility electrolytes. Sample ions that diffuse back into the terminating electrolyte “speed up” under the higher electric field, and those that diffuse forward into the leading electrolyte region slow down under the lower electric field.

This ITP stacking provides efficient concentration of very dilute samples, typically by a factor of 400 or more, depending on the lengths of the respective channel regions. By this method, a sample bolus several cm long (depending on the design of the microfluidic device) can be stacked into a narrow band. The limitation of ITP as a separation technique, however, is lack of resolution of dilute sample components. Accordingly, a combination of ITP stacking and zone electrophoresis (ZE), which is better able to spatially resolve dilute sample components of different electrophoretic mobility, is used. Conditions allow for initial small-volume stacking of a large initial sample volume by ITP, followed by a transition to ZE once ITP stacking is achieved.

In operation, after the stacking step just described, when the sample components have become stacked within a region of the electrolyte channel which is downstream of second side channel 32, a voltage potential is applied between reservoirs 34 and 30, thus drawing the leading electrolyte solution in reservoir 34 through the sample components and toward the outlet reservoir 30 (FIG. 2F). As the more mobile ions of the leading electrolyte pass the ITP-stacked sample ions, zone electrophoretic separation commences, such that the samples separate into discrete bands according to their electrophoretic mobility, and can be individually detected by a detector (not shown) near outlet reservoir 30.

In one embodiment of the method, at each step of the method as described above, the electrodes not specifically described are allowed to float, as indicated by “F” in the Figures. (As used herein, “floating” indicates that the electrode is not in electrical communication with any of the other electrodes in communication with the fluid in the device via any electrical wiring or solid-state circuitry, although it is in electrical communication via the conductive electrolyte solutions in the various interconnected channels.) This embodiment provides a simple to execute voltage scheme and can employ fewer separate high voltage sources. However, one of skill in the art could envision variations in which the end results of the above-described steps are achieved while applying voltages to one or more additional electrodes, up to and including all of the electrodes in the system. For example, voltages could be applied to counter diffusion of sample, to provide sharper sample boundaries. In addition, steps described separately above could in some cases be carried out to some degree simultaneously. For example, elution by leading electrolyte (illustrated in FIG. 2F) could coincide to some extent with migration and stacking of sample (illustrated in FIG. 2E).

B. Sample Components

Samples used for separation may include those typically separated by electrophoretic techniques, including charged biomolecules such as peptides, proteins, nucleic acids, and polysaccharides, as well as charged synthetic polymers. The method is also particularly suitable for separation of electrophoretic markers known as eTags™. eTag™ reporters are sets of fluorescently labeled molecules with distinct and well-defined electrophoretic mobilities. For use in assays, such labels are coupled to biological or chemical probes via cleavable linkages. Assays are designed such that, when an eTag™ reporter-labeled probe binds to a target, the coupling linkage is cleaved and the eTag™ is released. Electrophoretic probes and tags of this type, and methods for their use in multiplexed assays, are described, for example, in co-owned PCT Pubn. Nos. WO 01/83502 and WO 00/66607, which are incorporated by reference herein. Since each eTag™ reporter has a well-defined electrophoretic mobility, ITP pre-concentration methodologies and protocols for separation of the reporters can be standardized. The eTag™ reporter technology enables solution-phase, multiplexed assays for gene expression, protein expression, receptor and enzyme profiling, with the same biological sample, directly from cell lysates. See, for example, Section III.D below.

The sample concentration may vary widely, depending on the nature of the sample, the number of components, the ease with which they can be separated, etc. Generally, the total concentration of the components of the sample to be assayed will be in the range of about 0.1 pM to 1 μM, although higher concentrations, up to about 100 μM, can also be assayed. Detection levels as low as 40 fM (0.04 pM) have been demonstrated using the above-described method (see below).

C. Electrolyte Components

The concentrations of the electrolyte solutions are generally in the range of about 0.1 mM to 1 M, more usually in the range of about 1 to 50 mM.

For separation of negatively charged components, suitable leading electrolytes include salts of chloride, bromide, fluoride, phosphate, acetate, nitrate, and cacodylate (dimethylarsenate). The cationic counterion can be chosen to buffer the system in the desired pH range. For example, TRIS could be used for a pH of 8, and imidazole for a pH of 7. Other useful cationic counterions include histidine, β-alanine, ammonium, and alkali and alkaline earth ions, such as sodium, lithium, potassium, and magnesium.

Suitable terminating electrolytes, having low mobility anions, include HEPES, TAPS, MOPS (3-(4-morpholinyl)-1-propanesulfonic acid), CHES (2-(cyclohexylamino) ethanesulfonic acid), MES (2-(4-morpholinyl)ethanesulfonic acid), glycine, alanine, and β-alanine.

Further general guidance in selection of leading and terminating electrolytes for ITP stacking, for separation of positively charged as well as negatively charged species, can be found in references such as Everaerts, Beckers, & Verheggen, Isotachophoresis. Theory, Instrumentation and Applications; Elsevier: Amsterdam, 1976.

II. Illustrative Separations

In the experiments described below, the following conditions were employed, unless otherwise indicated. For ITP/ZE separations, the leading electrolyte (LE) was 20 mM HCl/25 mM imidazole, pH 6.5, containing 1% polyethylene oxide (MW 600K, Aldrich, Milwaukee, Wis.). The PEO was added to increase the viscosity of the buffer to counteract hydrostatic flow and to reduce electroosmotic flow (EOF) by coating the channel walls. The terminating electrolyte (TE) was 20 mM HEPES/10 mM imidazole, pH 6.7, or alternatively 40 mM HEPES/160 mM imidazole, pH 7.7. Comparative experiments in ZE mode were carried out in the LE buffer.

The microfluidic device (“chip”) used for ITP/ZE had a sample loading region (36 in FIG. 1) 2 cm in length, and a “separation region” (between the intersection of channels 14 and 34 and the detector, which was situated near outlet reservoir 30) 5 cm in length. Other channels were 0.5 cm to 1.5 cm in length. The comparative experiments in ZE mode were performed on chips having an electrolyte channel and two directly opposing side channels, to form a cross network, with sample injected in standard ZE chip operating mode, as described, e.g., in McCormick et al. and Xue et al. The channels in the ZE chips had the same cross-sectional areas as in the ITP/ZE chips. The channel cross sections were either 30 μm deep×80 μm wide or 50 μm deep×120 μm wide. Electrolyte wells were 3 mm in diameter and 1.5 mm deep, having a volume of 8-10 μL. The devices were injection molded poly(methyl methacrylate) (PMMA) bonded with a PMMA cover film as previously described (Cronin et al.; McCormick et al). A movable microscope stage allowed detection on any point on the devices.

In the ITP/ZE separations exemplified below, at any given step, a single electrode was at “high” voltage, and another single electrode was set to ground, while the other electrodes were floating. The field strengths varied from 300-700 V/cm.

Comparative experiments in ZE mode used a voltage scheme with sample “pullback” (McCormick et al.; Xue et al), with voltages applied to four electrodes simultaneously. Briefly, a high voltage potential is applied between the upstream and outlet reservoirs, and a same direction but lesser voltage potential is applied to the sample and drain reservoirs. This “pullback” scheme serves to direct any sample present in the side channels away from the downstream separation channel, to reduce diffusion or migration of sample components into the separation channel during separation.

A. Detection of Stacked and Separated Samples

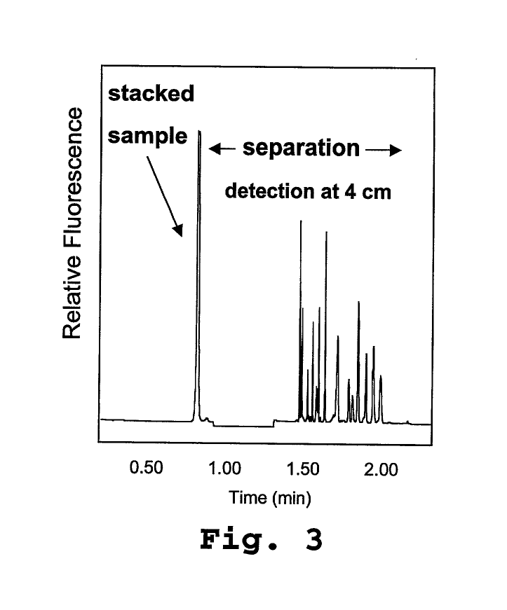

Stacking and separation in accordance with an embodiment of the invention are illustrated in FIG. 3, which shows detection of stacked sample (left side of scan) and separated sample (right side of scan) in different regions of a microfluidic device such as shown in FIG. 1. The sample was a mixture of 13 negatively charged, fluorescein labeled eTag™ reporters (as described above), having the designations and electrophoretic mobilities listed in Table 1.

TABLE 1
Mobilities of eTag ™ reporters, measured in the LE buffer at pH 6.5

| | Mobility(10⁻⁵) |
|---|---|
| eTag ™ reporter | cm²/Vs |
| ACLA 163 | 34.0 |
| ACLA 156 | 33.1 |
| ACLA 33 | 32.0 |
| ACLA 26 | 29.1 |
| ACLA 25 | 27.8 |
| ACLA 174 | 26.5 |
| ACLA 1 | 23.9 |
| ACLA 187 | 21.5 |
| ACLA 188 | 19.1 |
| ACLA 189 | 17.5 |
| ACLA 190 | 16.4 |
| ACLA 191 | 15.5 |
| ACLA 192 | 14.9 |

Sample concentrations ranged from 200-400 pM for the individual eTag™ reporters. Chloride was used as the leading ion and HEPES as the terminating ion. Imidazole was the buffering counterion in both the LE and TE buffers. The pH values of the leading and terminating electrolyte, respectively, were 6.5 and 6.7. The injected sample plug length of the eTag™ reporters was 2 cm.

With reference to FIG. 1, stacked sample was detected in the channel segment between side channels 28 and 34, at the intersection of channels 14 and 34, and in channel segment 14 just downstream of channel 34. Separation was detected in channel segment 14, 4 cm downstream of channel 34. The electropherograms shown in FIG. 3 show that the LE and TE buffers stacked the sample components and that the subsequent switch to the LE buffer de-stacked and separated the sample components.

B. Comparison with ZE

The present method allows injection of a large sample volume, which is then stacked to a small band, and efficiently separated following addition of the LE buffer (e.g. as illustrated in FIG. 2F). This separation method provides very high sensitivity compared to zone electrophoretic separation in a microfluidic device, carried out as described in McCormick et al. and Zue et al.

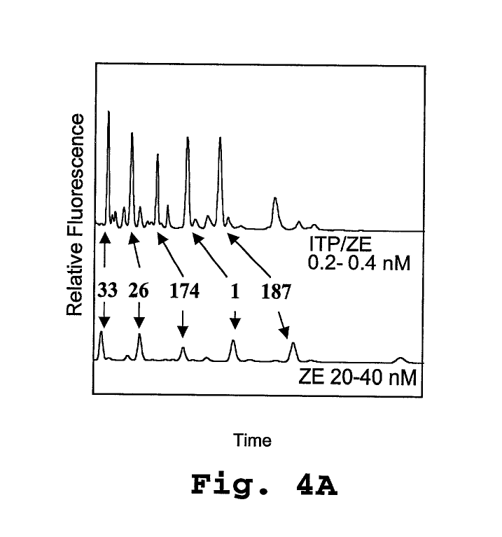

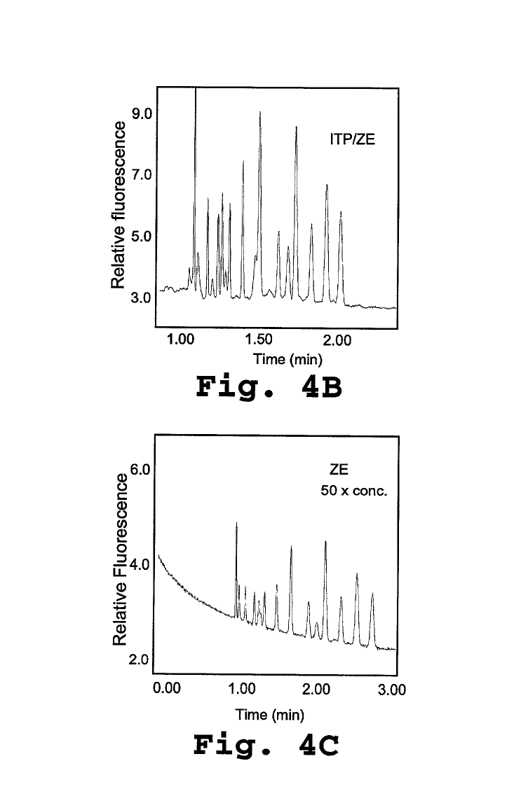

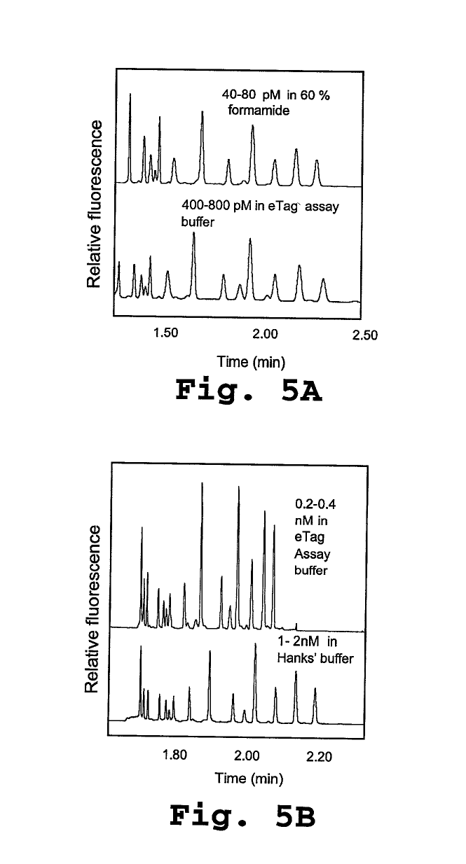

See, for example, FIGS. 4A-C, which compare separation by ITP/ZE, in accordance with the invention, with ZE separation of similar samples at much higher concentrations. FIG. 4A compares the signal response, at the same detector setting, from ITP/ZE separation as described herein (top scan) and ZE separation (lower scan) of a mixture of the 13 eTag™ reporters of Table 1. The sample was prepared in the same buffer for the two analyses (eTag™ assay buffer, described below) and was injected in a 100-fold lower concentration in the ITP/ZE separation mode, as shown in the Figure. Channel cross sections were 30×80 μm, and the size of the ITP/ZE injection plug was 2 cm. Detection was carried out at 4 cm from the stacking or injection point, respectively.

A comparison of peak heights showed an average sensitivity increase of 400 fold in ITP/ZE as compared to ZE, and the resolution between peaks (at half height) was only marginally higher for the ZE separation (Table 2). The signal sensitivity increase was found to be essentially independent of the eTag™ mobility.

TABLE 2

Resolution at hh

| eTag ™ reporter | Signal enhancement | ITP/ZE | ZE |
|---|---|---|---|
| ACLA 33 | 430 | 5.4 | 5.8 |
| ACLA 26 | 250 | 5.6 | 5.9 |
| ACLA 174 | 530 | 6.1 | 5.9 |
| ACLA 1 | 420 | 5.2 | 6.2 |

FIGS. 4B-C also show a comparison of signal response in ITP/ZE (FIG. 4B) and ZE (FIG. 4C) separation of 13 eTag™ reporters in eTag™ assay buffer, with the same detector setting and separation channel dimensions. Estimated sample plug length of the eTag™ reporters was 3-9 mm depending on analyte mobility. Detection was carried out at 4 cm from the stacking or injection point, respectively. The concentration of injected sample was 40-80 pM for ITP/ZE and 2-4 nM (about 50 fold greater) for ZE. Again, ITP/ZE gave higher intensity peaks even at a much lower sample concentration (see FIG. 4B). A good correlation of migration times between the individual eTag™ reporters was obtained for the two separation modes, confirming that the online ITP stacking process does not compromise the ZE separation of the eTag™

C. Effect of Sample Buffer Ionic Strength

In studies in support of the present invention, buffers with varied ionic strengths were used for sample injection. As will be shown, efficient stacking and separation were obtained in both low and high conductivity buffers, including a physiological buffer with at least 140 mM salt. The limit of detection (LOD) was found to vary with sample buffer ionic strength.

ITP/ZE separations of eTag™ reporters were performed in the following sample buffers:

(1): Standard eTag™ assay buffer (10 mM MOPS,12.5 mM MgCl₂/0.05% Triton X100);

(2): eTag™ assay buffer, diluted 1:10 (1 mM MOPS, 1.25 mM MgCl₂/0.005% Triton X100)

(3): 60% formamide/40% H₂O (low conductivity)

(4): Hanks' Buffer with 0.1% BSA (138 mM NaCl, 5.3 mM KCl, 5.6 mM glucose, 4 mM NaHCO₃, 1.3 mM CaCl₂, with other salts less than 1 mM) (GIBCO/BRL/Life Sciences, Rockville, Md.) (high conductivity)

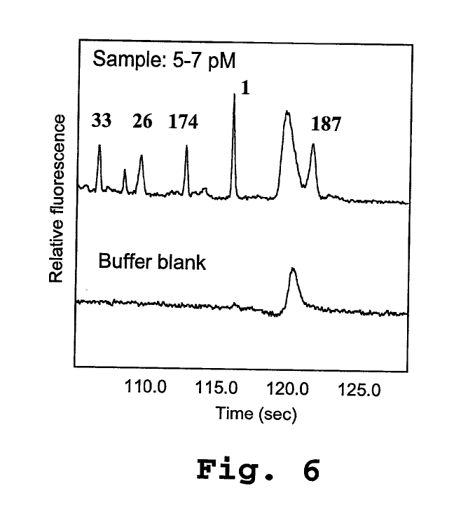

A comparison was made between separation of samples formulated in the eTag™ assay buffer (1) and in the low conductivity 60% formamide buffer (3). As shown in FIG. 5A, the low conductivity buffer (top scan) gave a tenfold sensitivity increase over assay buffer (bottom scan) at comparable resolution. Use of the high ionic strength Hanks' buffer (4) (FIG. SB, bottom scan) as compared to the eTag™ assay buffer (1) (top scan) gave a clear loss of detection sensitivity; however, the resolution was maintained or even improved.

The LOD (with S/N=3) was determined to be 0.4 pM for eTag™ reporters in assay buffer (1) run in accordance with the methods described herein, in a chip with a 2 cm long injection segment. The LOD (S/N=3) in Hank's buffer (4) was determined to be 3-4 pM for a fluorescein-labeled eTag™ derivative. The estimated LOD in a low conductivity buffer such as a 10 fold diluted eTag™ assay buffer (2) is 0.04 pM.

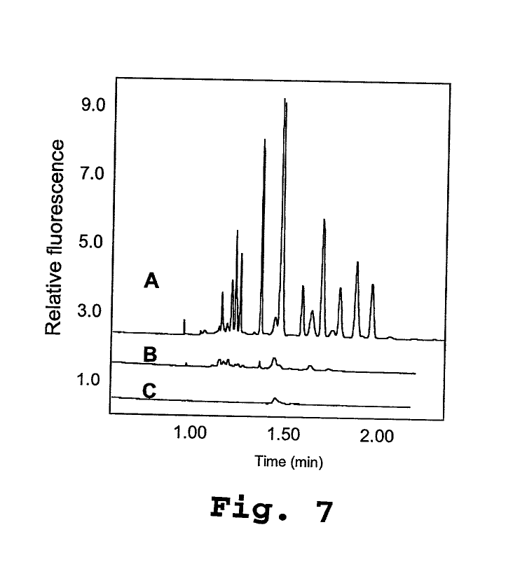

FIG. 6 shows an electropherogram from an ITP/ZE separation of a mixture of eTag™ reporters of known concentration in the pM range (5-7 pM), in the eTag™ assay buffer (1), in accordance with the present method. At these detection levels, the purity of buffer reagents can be critical, as can be seen from the presence of a fluorescent contaminant, present in low pM concentrations, in the buffer blank and the sample. This impurity peak was found to be pH sensitive and could thus be manipulated by buffer pH changes.

D. Cell Based Assays

The feasibility of analyzing cleaved eTag™ reporters from a multiplexed gene expression assay without any sample pre-treatment was evaluated as follows. A mixture of 13 eTag™ reporters as described above was added to lysed cell samples which contained all of the reagents that would be used in such an assay, as well as cell lysis buffer. This sample was analyzed by ITP/ZE, in accordance with the present method (FIG. 7, top scan), and compared to the cell lysate control (center scan) and to the assay buffer blank (bottom scan). As shown in the Figure, all eTags™ were resolved, and for samples in the high pM (200-400) range, the background was negligible.

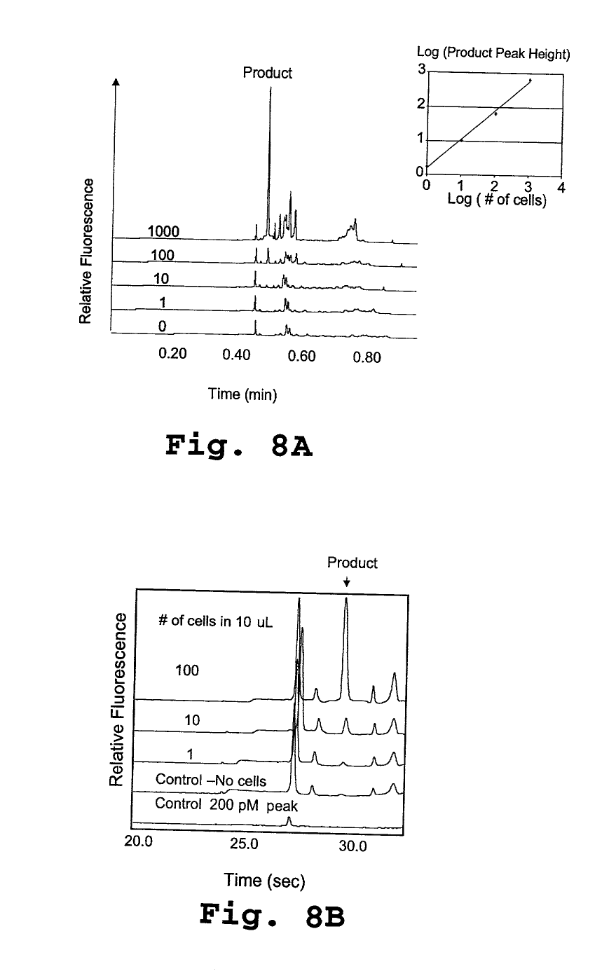

Live cell analysis was also carried out, with the ultimate goal of analysis of protein activity in single cells. FIG. 8A shows the results of an enzymatic assay for a cell surface protease (ADAM 17), based on the cleavage of the fluorescently labeled peptide substrate. The substrate itself cannot be detected; however, the cleaved fluorescently labeled peptide is negatively charged and can be detected by ITP/ZE. Samples with whole live cells in a physiological buffer, incubated with the substrate, were analyzed without any pre-treatment by ITP/ZE. The cleaved peptide product was easily detected, and there was a linear signal response with cell concentration (FIGS. 8A-B).

The additional peaks in the electropherograms were attributed to impurities, primarily in the substrate peptide, which was added to each sample to a 5 μM final concentration. An enlarged view of the samples with low cell concentrations (FIG. 8B), including a control of known concentration, clearly showed the sensitivity of this assay down to fewer than 10 cells/μL, corresponding to high pM detection of an enzymatic product.

E. Summary

The present method provides a sample separation method that gives high resolution, sharp peaks and high intensity signals from extremely low sample concentrations. The method allows injection of a large sample volume, which is then stacked to a small band, and efficiently separated following addition of “sweep” LE buffer. This separation method provides very high sensitivity compared to zone electrophoretic separation in a microfluidic device. In the ITP/ZE mode described, using a 2 cm long sample injection plug, sensitivity was increased by 400 fold over conventional chip ZE, and separation performance was comparable to that of chip ZE. As shown above, picomolar and even femtomolar quantities can be detected, and whole cell and live cell assays can be performed without sample purification. The method can be used, for example, for analysis of clinical samples, e.g. body fluid or tissue samples, or for detection of trace amounts of charged substances in environmental samples, such as ground water.

The method can be carried out in an automated manner, by automated voltage control of the different analysis steps. The method also presents other practical advantages for processing of samples when there may be a delay between sample injection and separation (e.g., when a number of samples are loaded onto individual devices, stored for some length of time, and then processed). Diffusion of sample which can occur during this delay is less problematic than in conventional zone electrophoresis, since migration of terminating electrolyte (as shown in FIG. 2D) “cleans out” any diffused sample in the sample channel (channel 20) and presents a clean sample boundary prior to analysis.

The invention now having been fully described, it will be apparent to one of ordinary skill in the art that many changes and modifications can be made thereto without departing from the spirit or scope of the appended claims.

It is claimed:

1. A method for injecting a sample comprising a plurality of charged components and separating the components by electrophoresis in a microfluidics device,
wherein said microfluidics device includes:
a separation channel, having an upstream junction at which first and second channels intersect, said first and second channels terminating in first and second reservoirs, designated T and S/D, respectively;
a first side channel, intersecting said separation channel downstream of said junction, and terminating in a first side reservoir, designated D/S;
a second side channel intersecting one of said separation channel, first channel, and second channel, and terminating in a second side reservoir, designated L;
an outlet reservoir at a downstream terminus of said separation channel; and, for each said reservoir, an electrode in fluid contact with the reservoir; the method comprising:
(a) placing into said channels and reservoirs, a leading electrolyte solution, comprising an ion with higher mobility in an electric field than any of said charged sample components;
(b) placing into one of said S/D reservoir and said D/S reservoir, the sample solution, and placing into said T reservoir, a terminating electrolyte solution, comprising an ion with lower mobility in an electric field than any of said charged sample components;
(c) creating a voltage gradient between the S/D reservoir and the D/S reservoir, such that the sample solution migrates into a sample-loading region of the separation channel, between said upstream junction and said first side channel;
(d) creating a voltage gradient between the T reservoir and the S/D reservoir, such that the terminating electrolyte solution migrates through the first channel, to an upstream boundary of the sample solution in the sample-loading region, and into the second channel;
(e) creating a voltage gradient between the T reservoir and the outlet reservoir, such that the sample components become stacked within a region of the separation channel which is downstream of the second side channel; and
(f) creating a voltage gradient between the L reservoir and the outlet reservoir, such that leading electrolyte solution migrates from said second side channel and through said stacked sample components,
whereby the sample components move through the separation channel and separate into discrete bands according to their electrophoretic mobilities.

2. The method of claim 1, wherein, in steps (c)-(f), voltages are applied to the two electrodes specified, and the remaining electrodes are in a floating state.

3. The method of claim 1, wherein the sample solution is placed into reservoir S/D, and in step (c), the sample solution migrates into said separation channel region in a downstream direction.

4. The method of claim 1, wherein the sample solution is placed into reservoir D/S, and in step (c), the sample solution migrates into said separation channel region in an upstream direction.

5. The method of claim 1, wherein the second side channel intersects the separation channel, downstream of the first side channel.

6. The method of claim 1, wherein the second side channel intersects the first or second channel.

7. The method of claim 1, wherein the second side channel intersects the separation channel, at a position directly opposite the first side channel.

8. The method of claim 1, wherein the sample-loading region of the separation channel, between the upstream junction and the first side channel, is about 0.5-5 cm in length.

9. The method of claim 1, wherein the second side channel contains a leading electrolyte solution different from that used to fill the remaining channels in step (a).

10. The method of claim 1, further comprising, following step (c) and prior to step (d):
creating a voltage gradient between (i) a reservoir downstream of the first side channel and (ii) reservoir S/D, such that a desired amount of sample solution is displaced from the sample-loading region into the S/D channel.

11. The method of claim 2, wherein the electrodes are controlled by a single high voltage power source which employs multiplexed switching among the electrodes.

12. The method of claim 1, wherein the charged components are selected from the group consisting of nucleic acids, proteins, polypeptides, polysaccharides, and synthetic polymers.

13. The method of claim 1, wherein the charged components comprise labeled molecules having distinct and characterized electrophoretic mobilities, said molecules having been cleaved from molecular species with biological or chemical recognition properties in the course of a multiplexed chemical or biochemical assay.

14. The method of claim 13, wherein the sample solution further comprises a cell lysate and reagents used in said assay.

15. The method of claim 13, wherein the sample solution further comprises live cells and reagents used in said assay.

16. The method of claim 1, further comprising detecting said separated components.

17. The method of claim 16, wherein the concentration of at least one detected sample component in said sample is less than 1 pM.

18. The method of claim 1, wherein said sample is a clinical sample derived from a body fluid or tissue sample.

19. The method of claim 1, wherein said sample is from an environmental source.
